(19) United States
(12) Patent Application Publication
(10) Pub. No.: US 2004/0211232 A1
(43) Pub. Date: Oct. 28, 2004

(54) Locking device with extending functions

(75) Inventors: Renny Tse-Haw Ling, Chung-Ho City (TW); Yung-Li Kuo, Chung-Ho City (TW); Chien-Fu Huang, Chung-Ho City (TW)

Correspondence Address: TROXELL LAW OFFICE PLLC, Suite 1404, 5205 Leesburg Pike, Falls Church, VA, 22041, US

(73) Assignee: Sinox Co., Ltd.

(21) Appl. No.: 10/717,490

(22) Filed: Nov. 21, 2003

(30) Foreign Application Priority Data
Apr. 22, 2003 (TW) 092206342

(51) Int. Cl. E05B 67/00; E05B 67/02

(52) U.S. Cl. 70/51; 70/52

(57) ABSTRACT

The present invention is related to the locking device with extending functions, a body of the locking device can optionally connect different additive members, such as an article with a hanging hole, a timer, a compass, a thermal meter, etc.

### BACKGROUND OF THE INVENTION

1. Field of the Invention

The present invention generally relates to a locking device with extending functions, which can be widely applied to some small types of locking devices, especially the functions as hanging, combining with a timer, a compass, a thermal meter, etc.

2. Description of the Prior Art

Referring to FIG. 1, which is a sketch of a locking device in prior arts. Generally, the locking device, a hanging lock, mainly comprises a body and a shackle connecting the body. A hole is mounted on a bottom corner of the body for a cable, a key ring penetrating in or a hanging purpose.

In prior arts, different markets or needs as adding holes, combining with timers, compasses, thermal meters, etc. were involved in design. The holes in prior arts were directly shaped up on the body, hence the hole is an important role to decide an appearance of the body. Besides, due to different dimensions or positions of additive articles on the bodies may change the designs of the bodies and the structures therein. As it can be seen, a manufacturer may be responsible for additional expense of redesign and labor fee. Further that, the additive articles or functions are non-replaceable, thus customers have no enough room to choose what they want.

### SUMMARY OF THE INVENTION

The main objective of the present invention is to offer a locking device with extending functions, the locking device cannot be changed its original type to add a penetrating hole or additive articles.

To reach the main objective, the locking device of the present invention is capable of extending its additional functions or altering additive articles with different functions depending on customer needs. The locking device comprises a body and an additive member capable of assembling with the body. The additive member is able to attach different structures or functions to be suitable with operations, therefore, the locking device is with different assemblies of the body and the additive member with variable structures or functions.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a sketch of a locking device in prior arts.

FIG. 2A to 2C are structural sketches of a preferred embodiment of the present invention.

FIG. 3A to 3C are views of a first preferred embodiment of an additive member and a locking device of the present invention.

FIG. 4A to 4B are views of actions and a second preferred embodiment for assembling the additive member and the locking device of the present invention.

FIG. 5A to 5B are views of actions and a third preferred embodiment for assembling the additive member and the locking device of the present invention.

FIG. 6A to 6C are views of actions and a fourth preferred embodiment for assembling the additive member and the locking device of the present invention.

FIG. 7A to 7C are views of actions and a fifth preferred embodiment for assembling the additive member and the locking device of the present invention.

FIG. 8A to 8B are views of actions and a fifth preferred embodiment for assembling the additive member and the locking device of the present invention.

FIG. 9 is a view of another embodiment of FIG. 8A.

FIG. 10A to 10B are views of actions and a sixth preferred embodiment for assembling the additive member and the locking device of the present invention.

FIG. 11 is a view of another embodiment of FIG. 10A.

FIG. 12A to 12B are views of actions and a seventh preferred embodiment for assembling the additive member and the locking device of the present invention.

FIG. 13A to 13B are views of actions and a eighth preferred embodiment for assembling the additive member and the locking device of the present invention.

FIG. 14A to 14B are views of actions and a ninth preferred embodiment for assembling the additive member and the locking device of the present invention.

FIG. 15A to 15C are views of actions and a tenth preferred embodiment for assembling the additive member and the locking device of the present invention.

FIG. 16 is a view of actions and a tenth preferred embodiment for assembling the additive member and the locking device of the present invention.

FIG. 17A to 17C are views of actions and a eleventh preferred embodiment for assembling the additive member and the locking device of the present invention.

FIG. 18 is a sketch of another embodiment of a body of the present invention.

FIG. 19 is a view of a twelfth preferred embodiment for assembling the additive member and the locking device of the present invention.

FIG. 20A to 20C are views of an eleventh preferred embodiment for assembling the additive member and the locking device of the present invention.

FIG. 21A to 21B are views of a thirteenth preferred embodiment for assembling the additive member and the locking device of the present invention.

FIG. 22 is a view of a fourteenth preferred embodiment for assembling the additive member and the locking device of the present invention.

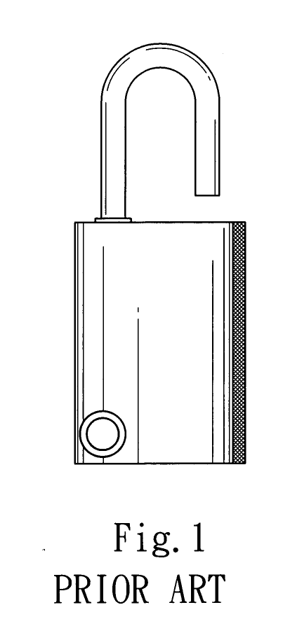

### DETAILED DESCRIPTION OF THE INVENTION

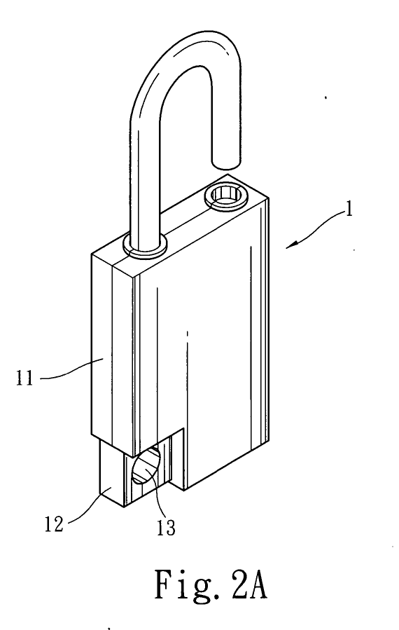

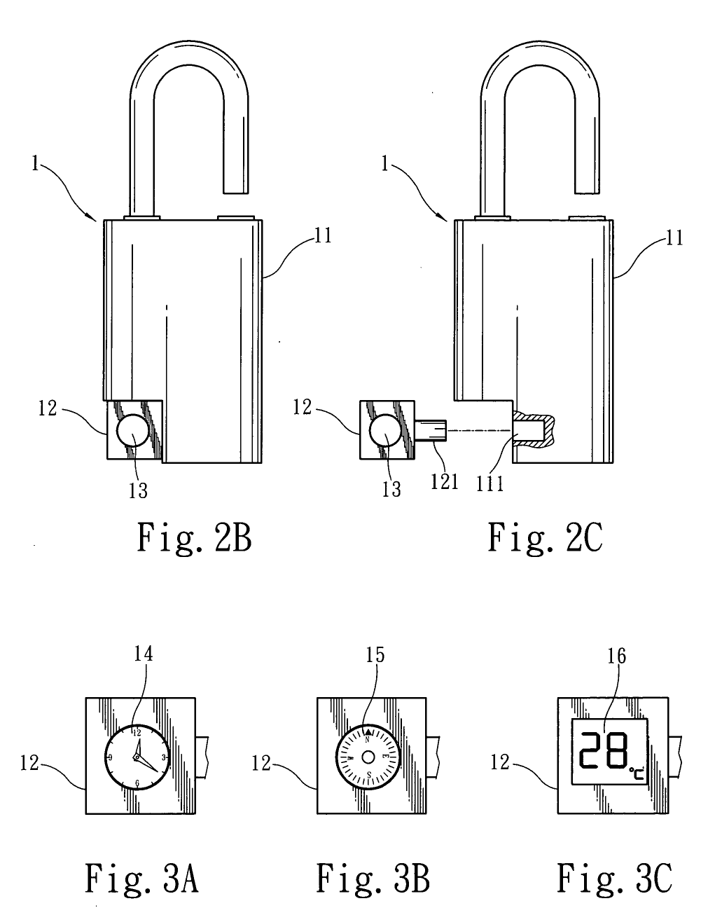

Referring to FIG. 2A to 2C are structural sketches of a preferred embodiment of the present invention. The preferred embodiment is related to a locking device 1 with extending functions, comprising a body 11 and an additive member 12. A structure of the body 11 is not only the embodiment shown in FIG. 2A to 2C, but also other locking mechanisms with locking and unlocking functions embedded in locking devices.

The additive member 12 can assemble with the body 11 and a hanging hole 13 is installed thereon, such as a timer 14, a compass 15, a thermal meter 16, etc. shown in FIG. 3A to 3C, which are views of a first preferred embodiment of an additive member and a locking device of the present invention, the additive member 12 and the body 11 have an extending slot 111 and an inserting leg 121. Further that, the additive member 12 tightly assembles with the body 11 by means of the extending slot 111 and the inserting leg 121.

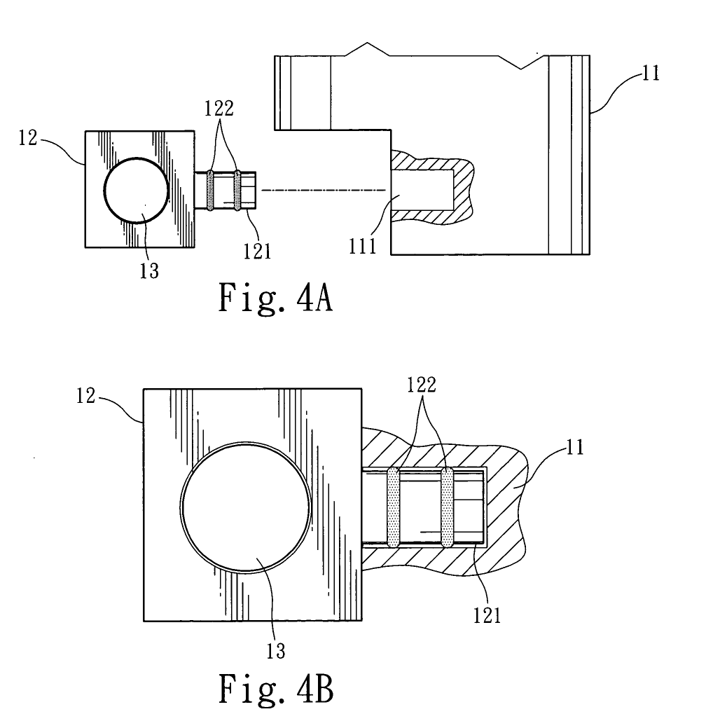

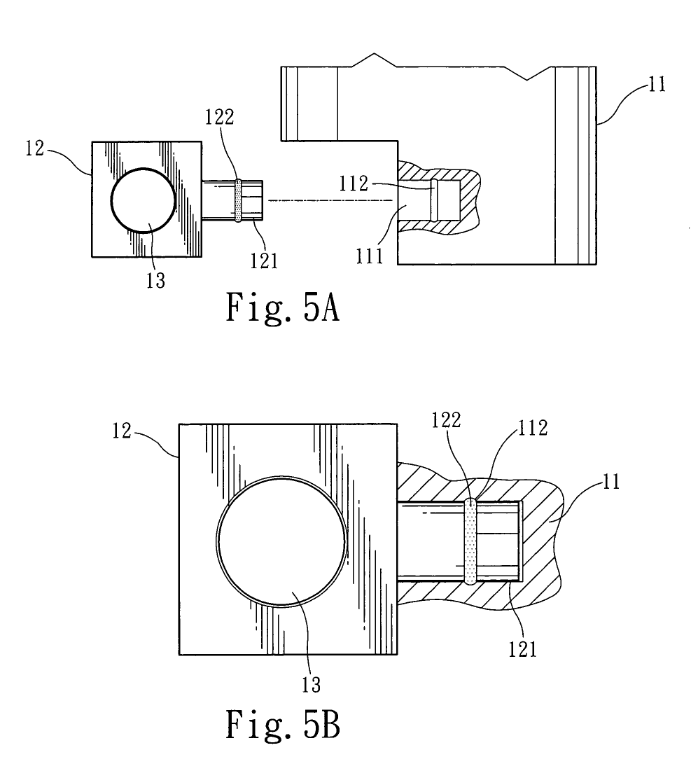

According to above mention, the body 11 cooperates with different external connecting members with different functions to be expandable. The inserting leg 121 combines in the extending slot 111 by way of force fit to let the additive member 12 firmly connect the body 11. Referring to FIG. 4A to 4B, which are views of actions and a second preferred embodiment for assembling the additive member and the locking device of the present invention. The embodiment is specially for that a gap exists between an outer surface of the inserting leg 121 and an inner surface of the extending slot 111, therefore a flexible non-skid ring 122, as rubber, soft plastic of material, is to be filled into the gap. Actually the non-skid ring 122 can be applied on the inserting leg 121 by different ways, such as distributed as a plurality dots, lines or surfaces. Referring to FIG. 5A to 5B, which are views of actions and a third preferred embodiment for assembling the additive member and the locking device of the present invention. Further that, a let-in slot 112 can be provided on the inner surface of the extending slot 111 to let the non-skid ring 122 fit in for positioning.

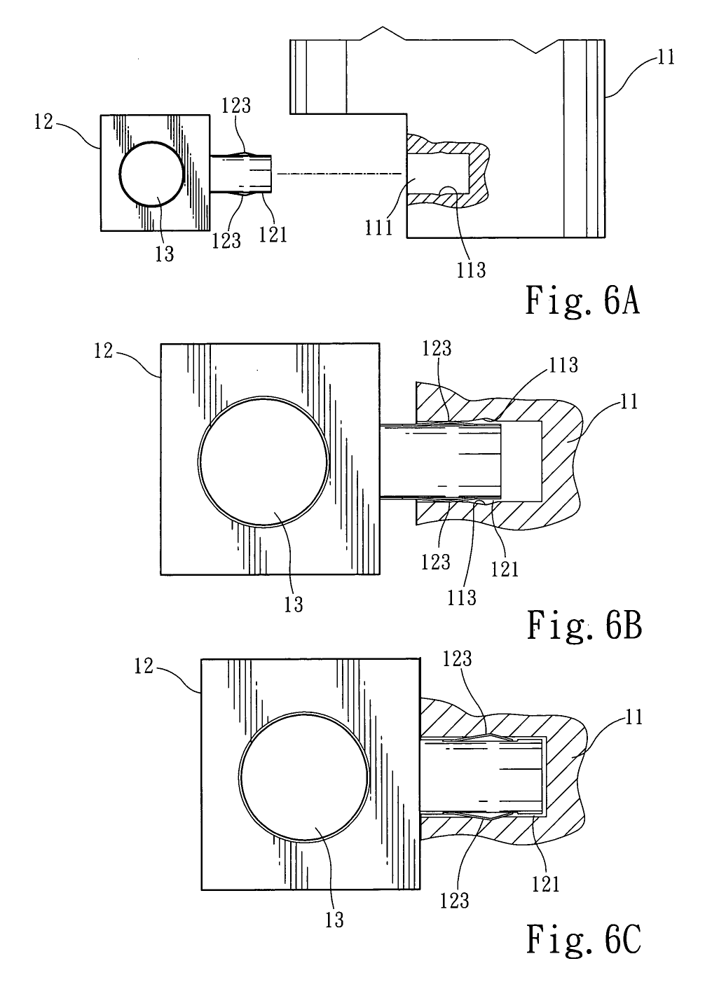

For connection and assembly of the inserting leg 121 and the extending slot 111, please refer to FIG. 6A to 6C, which are views of actions and a fourth preferred embodiment for assembling the additive member and the locking device of the present invention. A flexible member 123 is mounted on the outer surface of the inserting leg 121, one end of the flexible member 123 combines with a fixing end of the inserting leg 121, and another end is to assemble with an acting end. Based on the installment, the flexible member 123 can be deformed to enter into the extending slot 111 by a pushing force and against the inner surface of the extending slot 111 or a set-in slot 113 inside the extending slot 111.

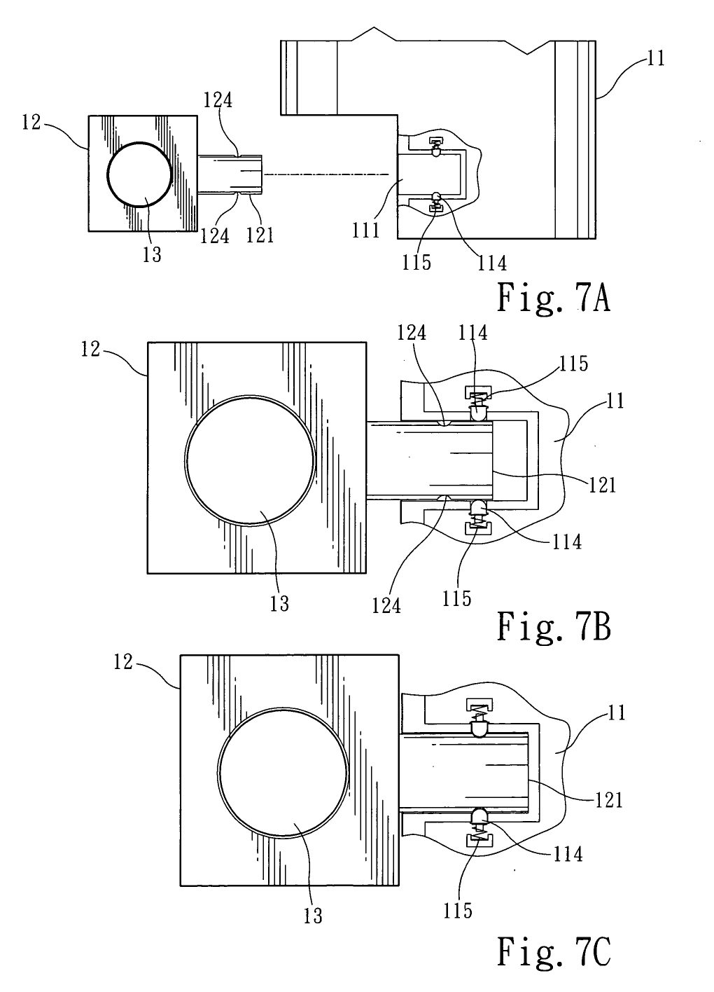

Referring to FIG. 7A to 7C, which are views of actions and a fifth preferred embodiment for assembling the additive member and the locking device of the present invention. At least one protruding member 114 and one flexible member 115 are in the body 11. The protruding member 114 is withstood by the flexible member 115 to get into the extending slot 111, and thus the protruding member 114 keeps on a certain position of the outer surface of the inserting surface 121 or a set-in slot 124 of the outer surface of the inserting surface 121.

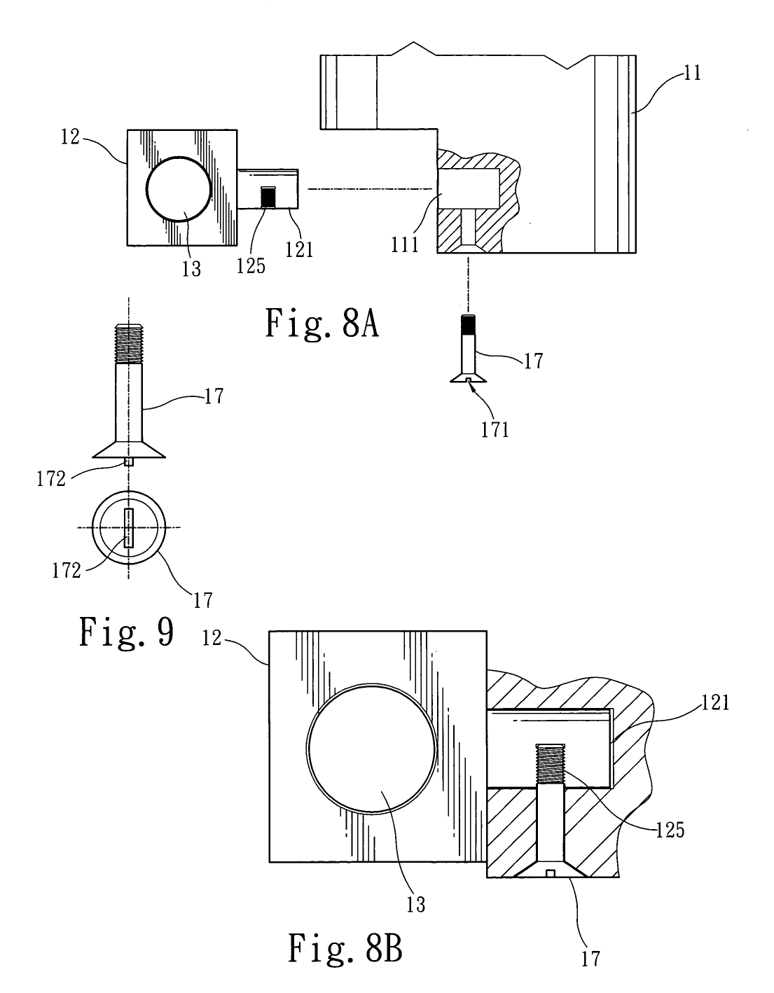

Referring to FIG. 8A to 8B, which are views of actions and a fifth preferred embodiment for assembling the additive member and the locking device of the present invention. A screw 17 is applied in the body 11 and penetrates through the extending slot 111. The screw 17 is stopped on the outer surface of the inserting leg 121, or the screw 17 stops screwing while it reaching into a certain period of a screw hole 125.

Referring to FIG. 9, which is a view of another embodiment of FIG. 8A. To assemble the screw 17 and the screw hole 125 is optionally a bolt, which top can be set up a fillister 171 for a screw driver driving or a rotating head 172 with a ridge for a hand handling.

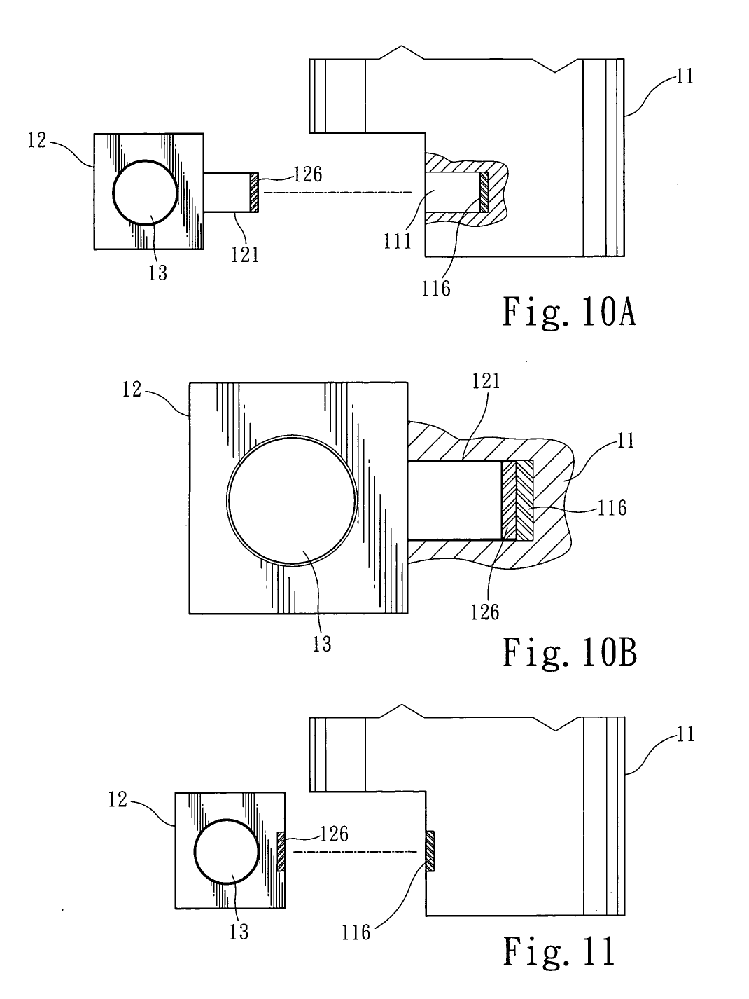

Referring to FIG. 10A to 10B, which are views of actions and a sixth preferred embodiment for assembling the additive member and the locking device of the present invention. The embodiment discloses that two magnetic members 116 and 126 are individually attached to the extending slot 111 and the inserting leg 121, and the two magnetic members 116 and 126 can be as magnets. Referring to FIG. 11, which is a view of another embodiment of FIG. 10A. The embodiment shows the two magnetic members 116 and 126 can be placed on any surfaces independently. A point here may be expressed, the two magnetic members 116 and 126 can be either that both are with magnetic features or one of them is a magnet, one is an attracted object, such as a metal piece or a metal block.

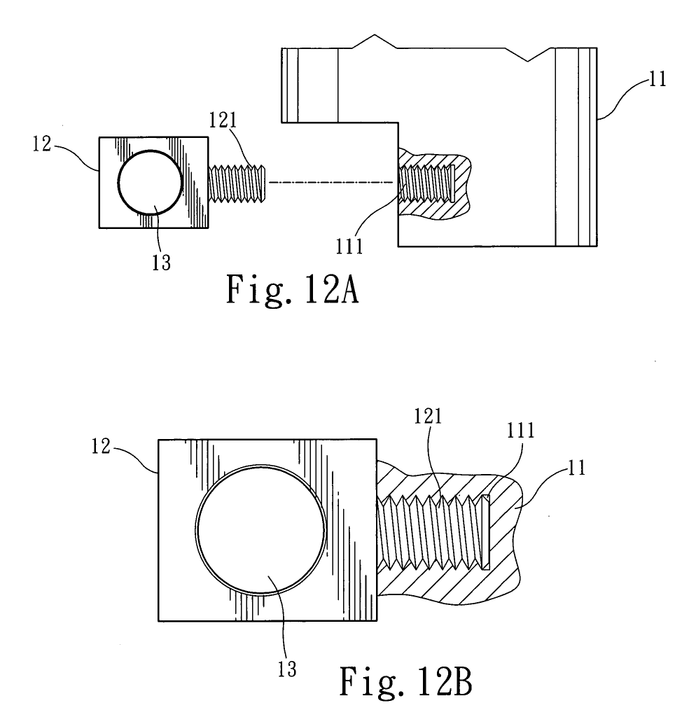

Referring to FIG. 12A to 12B, which are views of actions and a seventh preferred embodiment for assembling the additive member and the locking device of the present invention. The embodiment reveals a plurality of threads and mesh gears are separately set on the inner surface of the extending slot 111 of the body 11 and the outer surface of the inserting leg 121 of the additive member 12. Therefore, the inserting leg 121 and the extending slot 111 become a screw column and a screw hole to let the additive member 12 and the body 11 fasten together tightly.

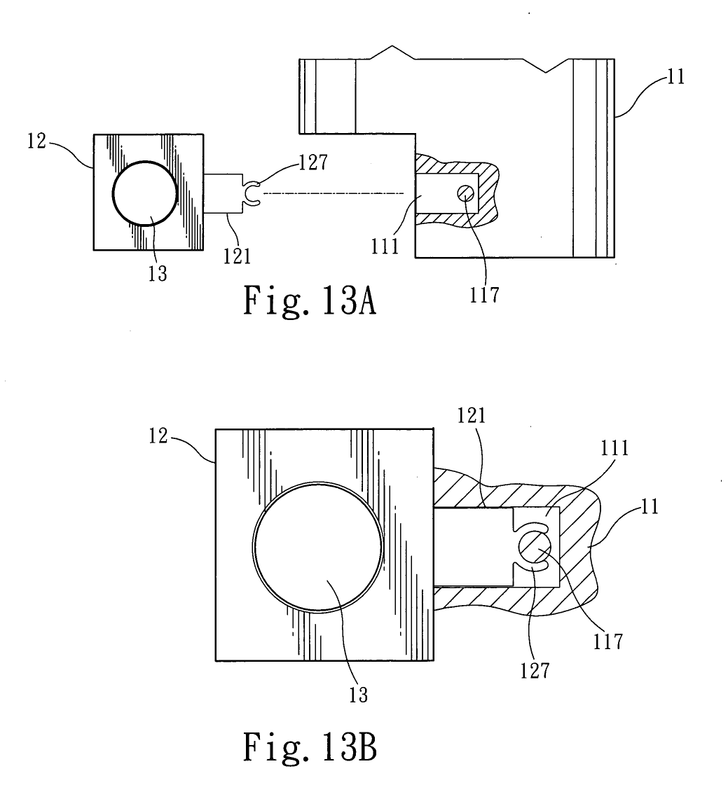

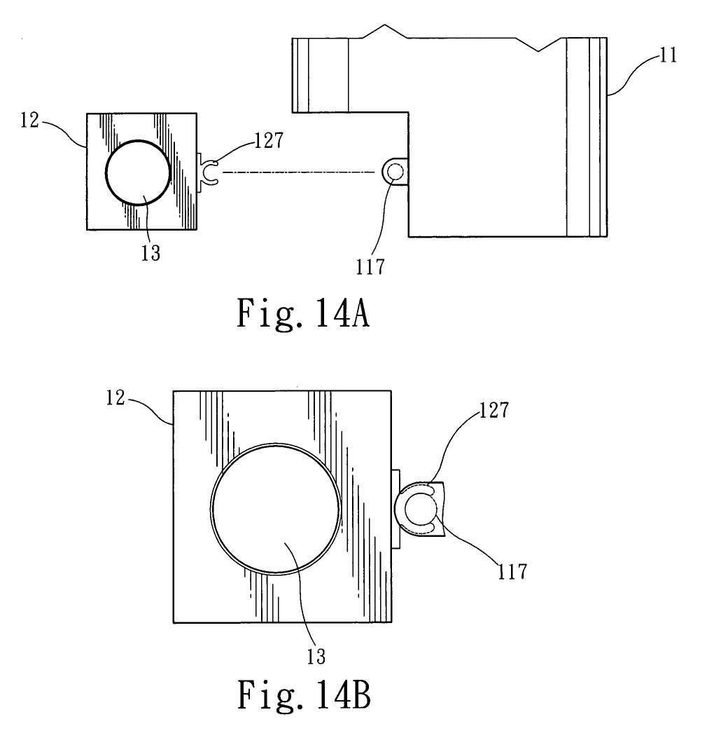

Referring to FIG. 13A to 13B, which are views of actions and a eighth preferred embodiment for assembling the additive member and the locking device of the present invention. The embodiment exposes that a pin 117 and a claw 127 are independently set in the extending slot 111 of the body 11 and on the inserting leg 121, the claw 127 fastens the pin 117 up to make the inserting leg 121 be combined with the extending slot 111. Referring to FIG. 14A to 14B are views of actions and a ninth preferred embodiment for assembling the additive member and the locking device of the present invention. The figures teach that the pin 117 and the claw 127 can not be positioned in the extending slot 111 and on the inserting leg 121 certainly; on the other hand, the pin 117 can be on the body 11 and the claw 127 is on an external side-surface of the additive member 12.

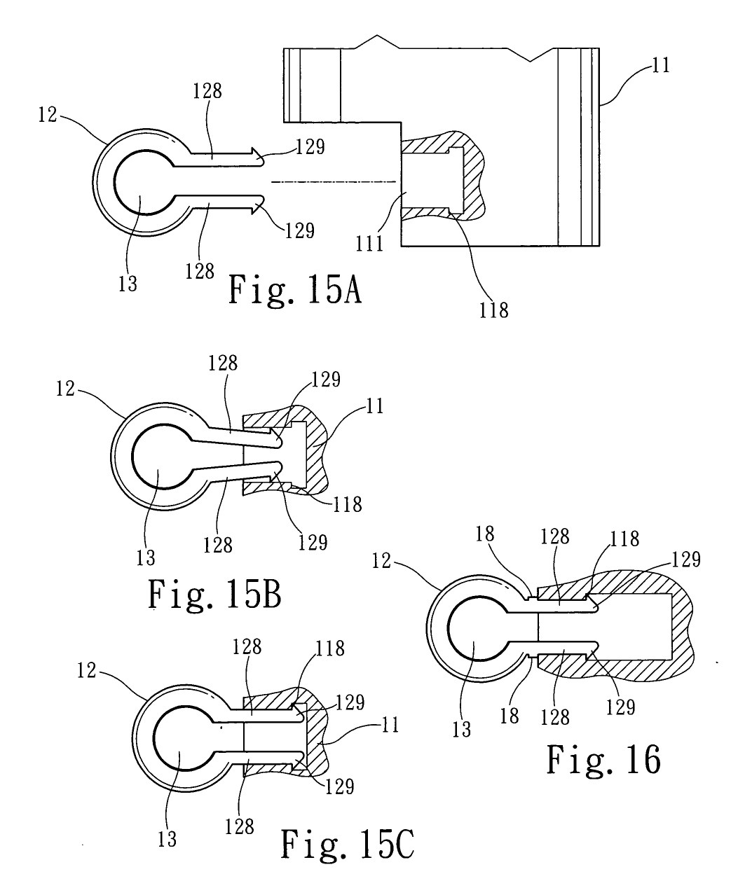

Referring to FIG. 15A to 15C, which are views of actions and a tenth preferred embodiment for assembling the additive member and the locking device of the present invention. The embodiment educates that the extending slot 111 is on the body 11 and an inner buckling rim 118 is shaped in the extending slot 111. The additive member 12 has a plurality of flexible arms 128, which ends having talons 129. The talons 129 individually elongate into the extending slot 111 to hook the inner buckling rim 118 up. Referring to FIG. 16, which is a view of actions and a tenth preferred embodiment for assembling the additive member and the locking device of the present invention. The embodiment demonstrates that at least one shoulder 18 is installed on the plurality of flexible arms 128, the shoulder 18 is against a surface of an opening of the extending slot 111 to let the flexible arms 128 elongate into the extending slot 111 in a certain length.

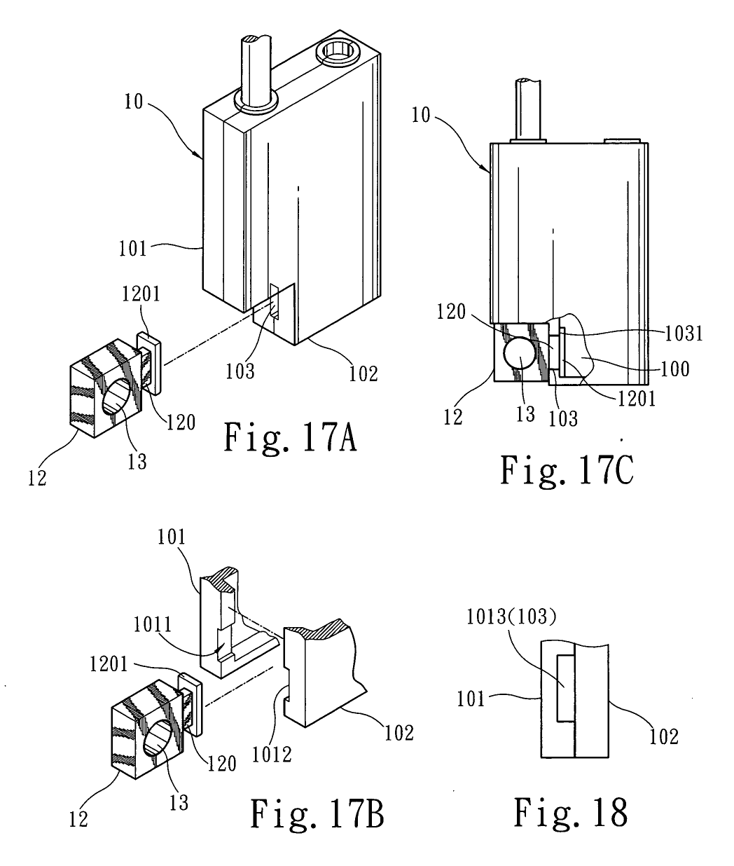

Referring to FIG. 17A to 17C, which are views of actions and a eleventh preferred embodiment for assembling the additive member and the locking device of the present invention. The body 11 has a casing 10 consisted of plural covers 101 and 102. A joint place of the covers 101 and 102 is an inserting hole 103, which is assembled by two breaches 1011 and 1012 of the two covers 101 and 102. Referring to FIG. 18, which is a sketch of another embodiment of a body of the present invention. The embodiment illustrates that a breach 1013 figured by the cover 101 cooperates with the cover 102 to form the inserting hole 103.

The additive member 12 comprises a neck portion 120 contained in the inserting hole 103 and at least one wing portion 1201 elongated from the neck portion 120. Firstly, the neck portion 120 is contained into the inserting hole 103 assembled by the breaches 1011 and 1012; secondly, the wing portion 1201 is mounted on an inner room 100 formed in the casing 10 and against an surface 1031 outside the inserting hole 103 so as to that the neck portion 120 cannot take off the inserting hole 103.

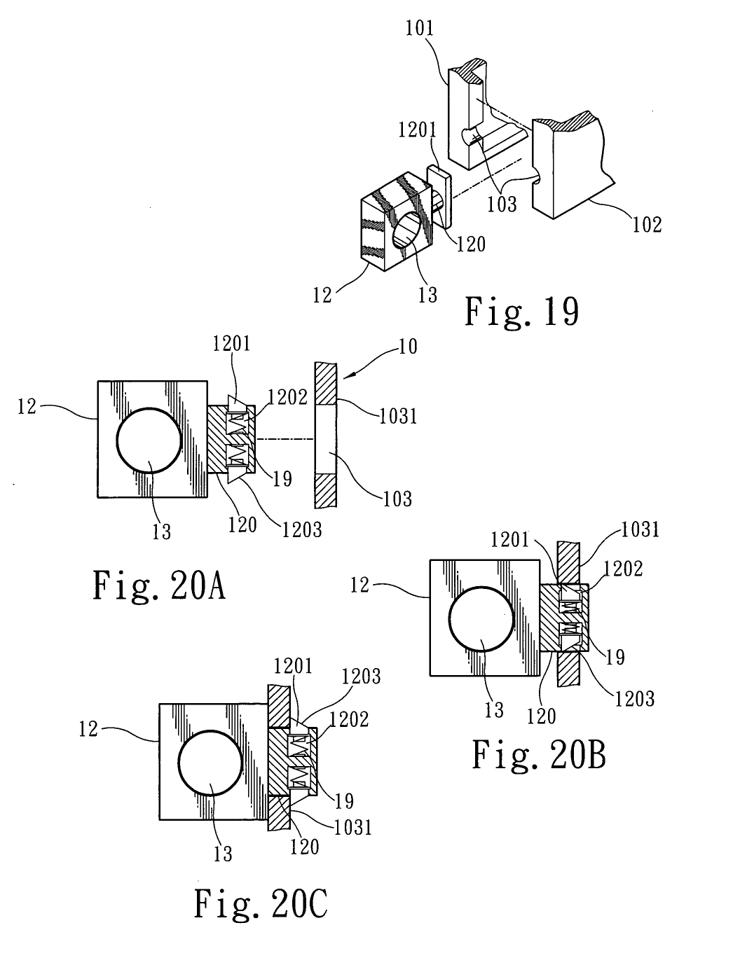

Referring to FIG. 19, which is a view of a twelfth preferred embodiment for assembling the additive member and the locking device of the present invention. The embodiment teaches that the additive member 12 can be as a rotational member, that is, the neck portion 120 is shaped as a column, and, the inserting hole 103 is figured as a hollow cylinder as well, hence the additive member 12 is capable of penetrating through the inserting hole 103 to be a rotational member. A cooperating relationship between the neck portion 120 and the inserting hole 103 may not be restricted by a fit of a column and a hollow cylinder, a room provided by the inserting hole 103 being enough for the neck portion 120 circulating is the basic condition.

Referring to FIG. 20A to 20C, which are views of an eleventh preferred embodiment for assembling the additive member and the locking device of the present invention. As the figures showing, a recess 1202 in the neck portion 120 is to reserve the wing portion 1201, and a flexible piece 19 is set in the recess 1202 to withdraw the wing portion 1201 to keep a state that the wing portion 1201 projects out of the neck portion 120 as always. Thus, the neck portion 120 with the wing portion 1201 is able to go through the inserting hole 103 after the wing portion 1201 drawing back to the recess 1202, and continuously the wing portion 1201 goes back to its original position after the neck portion 120 going through the inserting hole 103, the wing portion 1201 is then against the surface 1031 outside the inserting hole 103 so as to that the neck portion 120 cannot take off the inserting hole 103.

The above embodiment can further set an inclined surface 1203 on the wing portion 1201. That is, once the wing portion 1201 meets with an opening of the inserting hole 103, the inclined surface 1203 can help the wing portion 1201 drawing back to the recess 1202.

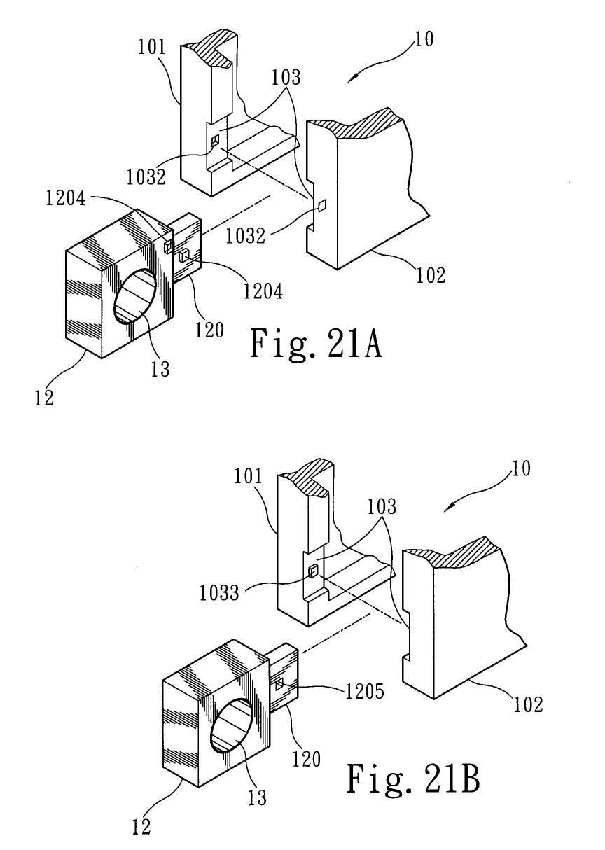

Referring to FIG. 21A to 21B, which are views of a thirteenth preferred embodiment for assembling the additive member and the locking device of the present invention. Same as the aforesaid embodiment, the casing 10 comprises the covers 101 and 102, a joint place of the covers 101 and 102 is the inserting hole 103, the additive member 12 is with the neck portion 120 capable of being contained in the inserting hole 103. The embodiment mainly discloses that two joint surfaces of the neck portion 120 and the inserting hole 103 are individually designed a projecting column 1204 and an inserting slot 1032, since this is a symmetrical design, therefore there are two projecting columns 1204 and two inserting slots 1032. The neck portion 120 is firstly put into the inserting hole 103 assembled by the breaches 1011 and 1012, the projecting columns 1204 and the inserting slots 1032 are matched each other to fasten the neck portion 120 and the inserting hole 103 together.

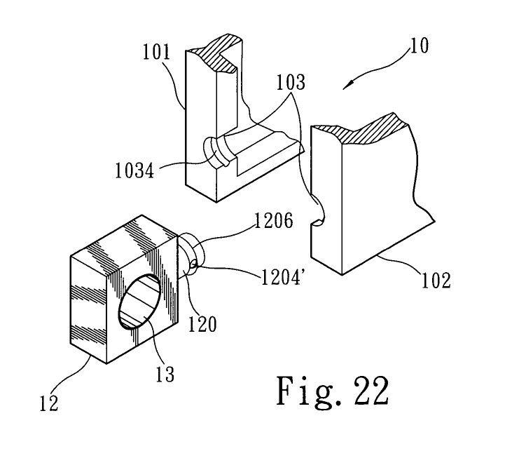

In FIG. 21B, an inserting slot 1205 on the neck portion 120 can be modeled as a penetrated hole through the neck portion 120, therefore two projecting columns 1033 on each of two inner surfaces of the inserting hole 103 can place in two openings of the inserting slot 1205. Same theory as aforesaid embodiments, the additive member 12 is possible of a rotational member. Referring to FIG. 22, which is a view of a fourteenth preferred embodiment for assembling the additive member and the locking device of the present invention. The neck portion 120 adopts a shape of column, and the inserting hole 103 is also a hollow cylinder, further, an inserting slot 1034 as a ring slot is designed on the inner surface of the inserting hole 103. According to the design, while a projecting column 1204′ of the neck portion 120 or a ring rib 1206 infixing in the inserting slot 1034, the additive member 12 can rotate by means of the neck portion 120. Under a condition of the projecting column 1204′ of the neck portion 120 or a ring rib 1206 infixing in the inserting slot 1034, figures of the neck portion 120 and the inserting hole 103 may not be round.

As a conclusion, the present invention is related to the locking device 1 with extending functions, the body 11 of the locking device 1 can optionally connect different additive members 12, such as an article with a hanging hole, a timer, a compass, a thermal meter, etc. In addition, the ways of the body 11 assembling with the additive members 12 are replaceable.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A locking device with extending functions, comprising:
a body;
an additive member; and
an extending slot and an inserting leg individually formed on the body and the additive member, the extending slot and the inserting leg being capable of joining each other.

2. The locking device with extending function as cited in claim 1, wherein the inserting leg combines with the extending slot by way of force fit.

3. The locking device with extending function as cited in claim 1, wherein an outer surface of the inserting leg has a non-skid ring, which is to be filled into a gap between the inserting leg and the extending slot.

4. The locking device with extending function as cited in claim 3, wherein the non-skid ring is of flexibility.

5. The locking device with extending function as cited in claim 3, wherein a let-in slot can be provided on an inner surface of the extending slot to let the non-skid ring fit in.

6. The locking device with extending function as cited in claim 1, wherein at least one flexible member is mounted on an outer surface of the inserting leg, the flexible member can be deformed to enter into the extending slot and against an inner surface of the extending slot.

7. The locking device with extending function as cited in claim 6, wherein a set-in slot inside the extending slot is to let the flexible member infix in.

8. The locking device with extending function as cited in claim 1, wherein at least one protruding member and one flexible member are in the body, the protruding member is withstood by the flexible member to be against the inserting leg as always.

9. The locking device with extending function as cited in claim 8, wherein the inserting leg has a set-in slot for the protruding member infixing in.

10. The locking device with extending function as cited in claim 1, wherein the body further combines with a screw, the screw penetrates through the extending slot and is stopped on the inserting leg.

11. The locking device with extending function as cited in claim 10, wherein the screw has a rotating head.

12. The locking device with extending function as cited in claim 1, wherein two magnetic members are individually attached to the extending slot and the inserting leg.

13. The locking device with extending function as cited in claim 12, wherein at least one of the two magnetic members has a magnetic feature.

14. The locking device with extending function as cited in claim 1, wherein a pin and a claw are independently set in the extending slot and on the inserting leg.

15. The locking device with extending function as cited in claim 1, wherein the extending slot can be screwed internally and the inserting leg can be screwed externally as well.

16. A locking device with extending functions, comprising:
a body having an extending slot, an inner buckling rim formed in the extending slot; and
an additive member having a plurality of elongated flexible arms, each of ends of the flexible arms having a talon, the talon elongating into the extending slot to hook the inner buckling rim.

17. The locking device with extending functions as cited in claim 16, wherein the additive member further set a shoulder to be against a surface of an opening of the extending slot.

18. A locking device with extending functions, comprising:
a casing having a plurality of covers, a joint place of the plurality of covers being an inserting hole; and
an additive member having a neck portion contained in the inserting hole and at least one fastening device being an interface for fixing between the neck portion and the inserting hole.

19. The locking device with extending functions as cited in claim 18, wherein the inserting hole and an inner room of the casing are connected each other, the wing portion elongates from the neck portion to the inner room and is against an surface outside the inserting hole.

20. The locking device with extending functions as cited in claim 18, wherein the additive member can rotate along the neck portion.

21. The locking device with extending functions as cited in claim 18, wherein a recess in the neck portion is to reserve the wing portion, and a flexible piece is set in the recess to withdraw the wing portion to keep a state that the wing portion constantly projects out of the neck portion.

22. The locking device with extending functions as cited in claim 18, wherein an inclined surface is formed on the wing portion.

23. The locking device with extending functions as cited in claim 18, wherein the fastening device can be a wing portion elongated from the neck portion to restrict that the neck portion taking off the inserting hole.

24. The locking device with extending functions as cited in claim 18, wherein the fastening device can be a plurality of projecting columns and an inserting slot individually installed on two joining surfaces of the neck portion and the inserting hole, the projecting columns and the inserting slot infixing each other while the inserting hole containing the neck portion.

25. The locking device with extending functions as cited in claim 24, wherein the inserting slot is in the neck portion and a penetrating hole through the neck portion.

26. The locking device with extending functions as cited in claim 24, wherein the inserting slot is formed on an inner surface of the inserting hole and shaped as a ring slot.
